(19) United States
(12) Patent Application Publication
(10) Pub. No.: US 2007/0011657 A1
(43) Pub. Date: Jan. 11, 2007

(54) System, method and viewer program to display a chart of current array values for an array data set

(76) Inventors: Yoshitaka Yanagida, Tokyo-to (JP); Hironori Komaba, Tokyo-to (JP)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/178,546

(22) Filed: Jul. 11, 2005

(51) Int. Cl. G06F 9/44

(52) U.S. Cl. 717/124

(57) ABSTRACT

A viewer program is disclosed for displaying current array values from a debugging program. In an embodiment, the viewer program comprises code to monitor the debugging program; code to analyze a selected variable identifier; code to obtain current array values related to the identifier; and code to chart the values. A system is disclosed for displaying current array values from a debugging program. In an embodiment, the system comprises a database; a text editor; and a viewer program. A method for displaying current array values from a debugging program is disclosed. In an embodiment, the method comprises monitoring the debugging program; analyzing a selected variable identifier; obtaining current array values; and displaying a chart of the values. A viewer program is disclosed for displaying current array values from a database. In an embodiment, the viewer program comprises a monitor application; an analyzer application; a receiver application; and a charting application.

### BACKGROUND

When running a software debugging program, a user may be shown the current values of many types of data variables. These data variables may include values expressed as integers or arrays. For an array of data variables, the user is shown the current value of each data element in the array. However, the characteristics of the array data are generally not apparent upon inspection of these data values. For instance, by looking at the array values, it may not be apparent that the data is periodic or noisy. Therefore, it is sometimes desirable to display the array values in a graphical format.

In order to graphically display array data during software debugging, the user generally has to first save the array data to a file. Then, the user must open the file in a charting application. Otherwise, the user needs to create a program to transfer the file containing the array data to the charting application.

### SUMMARY OF THE INVENTION

In one embodiment, there is provided a viewer program for displaying current array values from a debugging program, the viewer program comprising code to monitor the debugging program for user selection of a variable identifier; code to analyze the variable identifier selected by the user to i) determine if the variable identifier is an array identifier, and ii) locate an array data set corresponding to the variable identifier; code to obtain the current array values for the array data set from the debugging program; and code to display a chart of the current array values for the array data set.

In another embodiment, there is provided a system for displaying current array values from a debugging program, the system comprising a database in communication with the debugging program, the database storing i) current array values for at least one array data set, and ii) variable identifiers corresponding to the array data sets; a text editor displaying variable identifiers therein; and a viewer program in communication with the text editor, the viewer program comprising code to monitor the text editor for user selection of a variable identifier; code to analyze the variable identifier selected by the user to i) determine if the variable identifier is an array identifier, and ii) locate an array data set in the database corresponding to the variable identifier; code to obtain the current array values for the array data set from the database; and code to display a chart of the current array values for the array data set.

In yet another embodiment, there is provided a method for displaying current array values from a debugging program, the method comprising monitoring the debugging program for user selection of a variable identifier; analyzing the variable identifier selected by the user to i) determine if the variable identifier is an array identifier, and ii) locate an array data set corresponding to the variable identifier; obtaining the current array values for the array data set from the debugging program; and displaying a chart of the current array values for the array data set.

In an additional embodiment, there is provided a viewer program for displaying current array values from a database in a graphical format, the viewer program comprising a monitor application for monitoring the viewer program for a selection by a user of a variable identifier; an analyzer application for analyzing the variable identifier selected by the user to locate an array data set corresponding to the variable identifier; a receiver application for obtaining the current array values for the array data set from the database; and a charting application for displaying the current array values for the array data set.

Other embodiments are also disclosed.

### BRIEF DESCRIPTION OF THE DRAWINGS

Illustrative embodiments of the invention are illustrated in the drawings, in which:

FIG. 1 illustrates a diagrammatic screen display of a software debugging program, which includes a text editor component and a viewer component;

FIG. 2 illustrates a highlighted character portion within the text editor component of the FIG. 1 debugging program;

FIG. 3 illustrates a graphical display of current values of an array variable corresponding to the highlighted character portion from the FIG. 2 text editor, in which the current values of the array variable are received from a database accessed by the FIG. 1 debugging program;

FIG. 4 illustrates a block diagram of a system for graphically displaying current array values obtained from a debugging program; and

FIG. 5 illustrates a flow chart of a method for graphically displaying current array values obtained from a debugging program.

### DETAILED DESCRIPTION OF AN EMBODIMENT

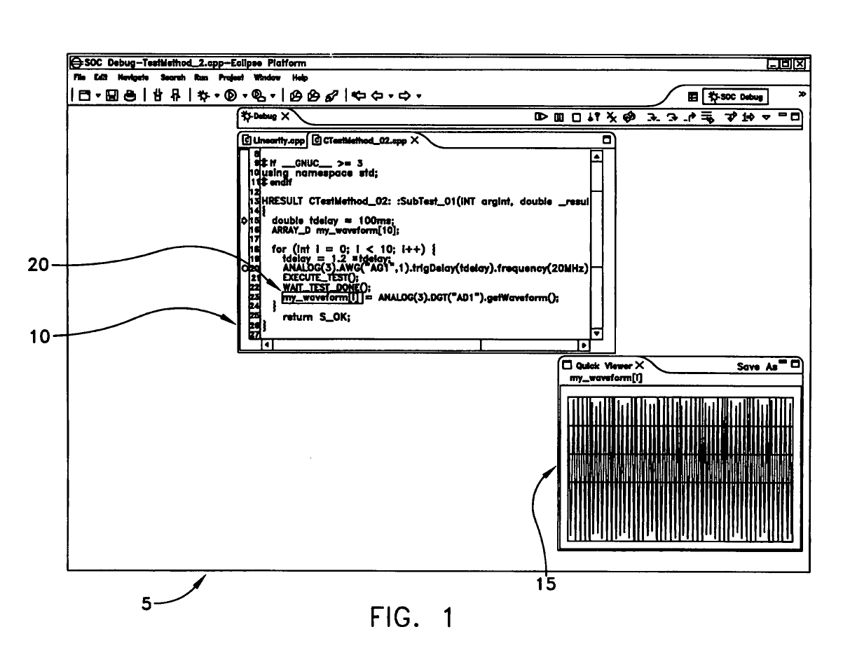

Looking at FIG. 1, there is shown a diagrammatic screen display 5 of a debugging computer software program, which includes a text editor display 10 and a viewer display 15.

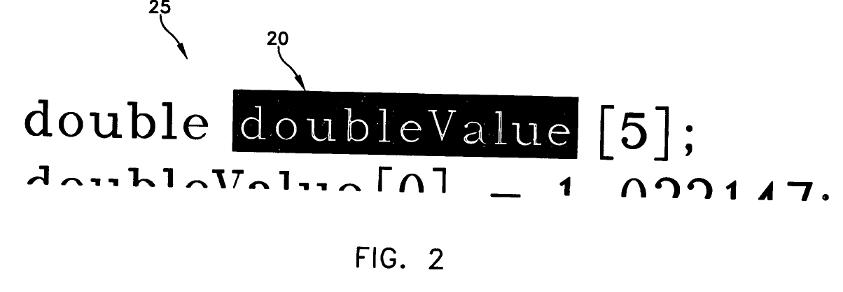

Looking at FIG. 2, there is shown a highlighted character portion of a variable identifier 20 within a text portion 25 of text editor display 10.

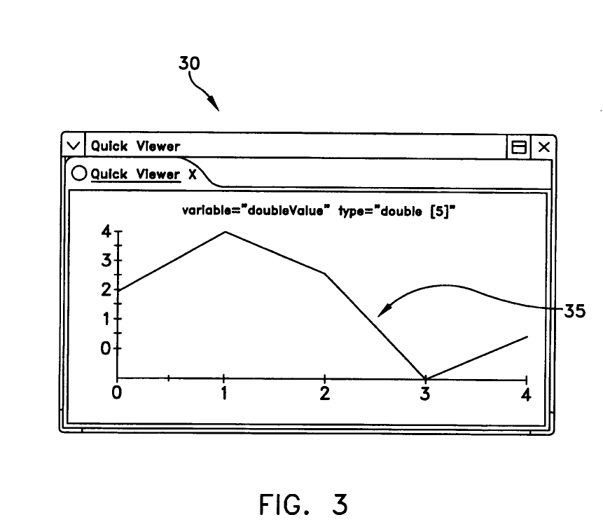

Looking at FIG. 3, there is shown a graphical display 30 of current array values 35 of an array variable corresponding to variable identifier 20, i.e., the highlighted character portion from text editor display 10.

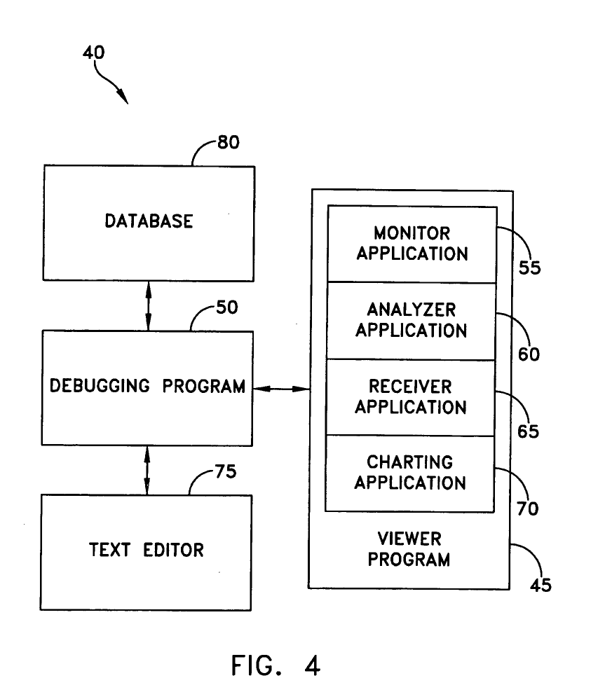

Looking at FIG. 4, there is shown a block diagram of a system 40 for displaying graphical data. A viewer program 45 is provided for more quickly displaying the structure of current array values 35 from debugging program 50 in a graphical format on viewer component 15 (FIG. 1).

In an embodiment, viewer program 45 comprises a monitor application 55, an analyzer application 60, a receiver application 65, and a charting application 70. Monitor application 55 is provided for monitoring debugging program 50 for a user's selection of variable identifier 20. Analyzer application 60 is provided for analyzing variable identifier 20 as selected by the user to locate an array data set corresponding to the selected variable identifier 20. Receiver application 65 is provided for obtaining current array values 35, which are generally in a rectangular arrangement of quantities in rows and columns, for the array data set from debugging program 50. Charting application 70 is provided for displaying current array values 35 for the array data set in a graphical format such as graphical display 30 (see FIG. 3).

In an embodiment, monitor application 55 is in communication with a text editor 75 of debugging program 50 so as to monitor text editor 75 for a selection by the user of variable identifier 20. Monitor application 55 of viewer program 45 may monitor text editor 75 of debugging program 50 for the user selection of variable identifier 20 by selection of a series of highlighted characters 20 (see FIG. 2).

In an embodiment, current array values 35 of the array data set are received from a database 80 accessed by the debugging program 50.

In an embodiment, current array values 35, which include a rectangular arrangement of quantities in rows and columns, are transferred from database 80 to viewer program 45 without transferring current array values 35 through text editor 75.

In another embodiment, a cursor within text editor display 10 is positioned over the text of variable identifier 20 for a given period of time to invoke monitor application 55 of viewer program 45 so as to select variable identifier 20. This can be accomplished either with or without highlighting the text of variable identifier 20.

In another embodiment, a cursor within text editor display 10 is positioned over the text of variable identifier 20 and a button of a mouse device is clicked to invoke monitor application 55 so as to select variable identifier 20. This can be accomplished either with or without highlighting the text of variable identifier 20. In one embodiment, a right button of the mouse is clicked to display a drop-down screen with the cursor over the text of variable identifier 20 and a choice is made from the drop-down screen to select variable identifier 20. This selection in turn causes the graphical display of variable identifier 20 within viewer display 15.

Analyzer application 60 analyzes the text of variable identifier 20 as selected by the user to determine if variable identifier 20 relates to a specific array data set. If the text of variable identifier 20 does not relate to an array data set, viewer program 45 cannot query debugger program 50 for current array values 35 from database 80. If the text of variable identifier 20 is related to an array data set, viewer program 45 queries debugger program 50 for current array values 35 of the array data set. Current array values 35 related to variable identifier 20 are transferred from database 80 of debugging program 50 to viewer program 45.

In an embodiment, viewer program 45 is integral with debugging program 50. As such, a single program contains the applications of both viewer program 45 and debugging program 50 such that each one of text editor 75 and database 80 view viewer program 45 and debugging program 50 as a single source of commands.

Referring to FIG. 4, there is shown system 40 for displaying current array values 35 from debugging program 50 in a graphical format. In an embodiment, system 40 comprises database 80, text editor 75, and viewer program 45. Database 80 is in communication with debugging program 50. Database 80 stores current array values 35 and variable identifiers 20 corresponding to current array values 35. Text editor 75 is provided for textual display of debugging information, including variable identifiers 20 related to array data set.

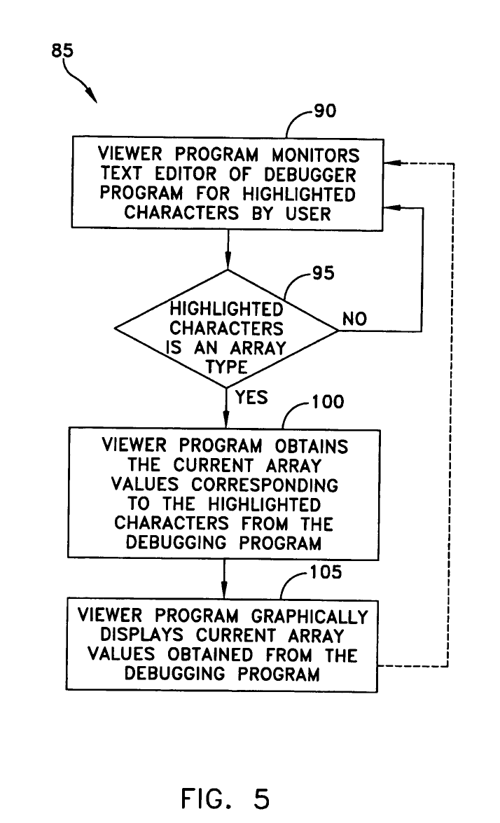

Looking at FIG. 5, and in an exemplary embodiment, a flow chart diagram 85 illustrates a method for displaying graphical data from debugging program 50. In a first part 90 of the method, viewer program 45 monitors text editor 75 of debugger program 50 for a selection by the user of variable identifier 20, such as highlighted characters. In a second part 95 of the method, a determination is made whether the highlighted characters relate to an array data set. In a third part 100 of the method, viewer program 45 obtains the current array values 35 from the array data set corresponding to the highlighted characters from debugging program 50. In a fourth part 105 of the method, viewer program 45 graphically displays current array values 35 obtained from debugging program 50.

In an embodiment, the method for displaying current array values 35 from debugging program 50 in a graphical format includes monitoring debugging program 50 for a selection by a user of variable identifier 20; analyzing variable identifier 20 selected by the user to locate an array data set corresponding to the text of variable identifier 20; providing current array values 35 for the array data set to viewer program 45 of debugging program 50; and displaying current array values 35 for the array type in viewer program 45.

One method for displaying current array values 35 may include monitoring text editor 75 of debugging program 50 for a selection by the user of variable identifier 20. For example, the method may include monitoring text editor 75 of debugging program 50 with viewer program 45 for a selection of the text of variable identifier 20 by the user.

In an embodiment, the method includes transferring current array values 35 from database 80 to viewer program 45 without transferring current array values 35 through the text editor 75.

In an embodiment, the method includes selection of variable identifier 20 by the user as a series of highlighted characters. Subsequently, the viewer program analyzes variable identifier 20 selected by the user to determine if variable identifier 20 is related to an array data set. If variable identifier 20 is not related to an array data set, viewer program 20 cannot query debugging program 50 for current array values 35 and continues to monitor text editor 75 of debugger program 50 for a selection by the user of variable identifier 20. If variable identifier 20 is related to an array data set, viewer program 45 queries debugging program 50 for current array values 35. Subsequently, current array values 20 are transferred from database 80 of debugging program 50 to viewer program 45.

In an embodiment, a viewer program is provided for displaying current array values from a database in a graphical format. The viewer program generally comprises a monitor application, an analyzer application, a receiver application and a charting application. The monitor application is provided for monitoring the viewer program for a selection by a user of a variable identifier. The analyzer application is provided for analyzing the variable identifier selected by the user to locate an array data set corresponding to the variable identifier. The receiver application is provided for obtaining the current array values for the array data set from the database. The charting application is provided for displaying the current array values for the array data set.

As discussed hereinabove, and in various embodiments, viewer program 45 does not require a user to handle array data, such as current array values 35, in order to display the contents of the array data set on a charting application. This is a significant advantage over other text viewers which require multiple steps by a user for graphically displaying data with array charting applications.

What is claimed is:

1. A viewer program for displaying current array values from a debugging program, the viewer program comprising:
code to monitor the debugging program for user selection of a variable identifier;
code to analyze the variable identifier selected by the user to i) determine if the variable identifier is an array identifier, and ii) locate an array data set corresponding to the variable identifier;
code to obtain the current array values for the array data set from the debugging program; and
code to display a chart of the current array values for the array data set.

2. The viewer program of claim 1 wherein the code to monitor the debugging program is in communication with a text editor of the debugging program so as to monitor the text editor for user selection of the variable identifier.

3. The viewer program of claim 2 wherein the code to monitor the debugging program monitors the text editor by monitoring characters that are highlighted by the user.

4. The viewer program of claim 3 wherein the code to obtain the current array values transfers the current array values from a database to the viewer program, without transferring the current values through the text editor.

5. The viewer program of claim 2 wherein the code to monitor the debugging program monitors the text editor by monitoring variable identifiers on which a cursor of the text editor is positioned for a given period of time.

6. The viewer program of claim 2 wherein the code to monitor the debugging program monitors the text editor by monitoring variable identifiers over which a graphical pointer is positioned for a given period of time.

7. The viewer program of claim 2 wherein the code to monitor the debugging program monitors the text editor by monitoring variable identifiers selected by a mouse click.

8. The viewer program of claim 1 wherein the viewer program is integral with the debugging program.

9. A system for displaying current array values from a debugging program, the system comprising:
a database in communication with the debugging program, the database storing i) current array values for at least one array data set, and ii) variable identifiers corresponding to the array data sets;
a text editor displaying variable identifiers therein; and
a viewer program in communication with the text editor, the viewer program comprising:
code to monitor the text editor for user selection of a variable identifier;
code to analyze the variable identifier selected by the user to i) determine if the variable identifier is an array identifier, and ii) locate an array data set in the database corresponding to the variable identifier;
code to obtain the current array values for the array data set from the database; and
code to display a chart of the current array values for the array data set.

10. A method for displaying current array values from a debugging program, the method comprising:
monitoring the debugging program for user selection of a variable identifier;
analyzing the variable identifier selected by the user to i) determine if the variable identifier is an array identifier, and ii) locate an array data set corresponding to the variable identifier;
obtaining the current array values for the array data set from the debugging program; and
displaying a chart of the current array values for the array data set.

11. The method of claim 10 wherein a text editor of the debugging program is monitored for a selection by the user of the variable identifier.

12. The method of claim 11 wherein the viewer program monitors the text editor of the debugging program for a selection of the variable identifier by the user.

13. The method of claim 11 wherein the current array values are transferred from a database to the viewer program without transferring the current values through the text editor.

14. The method of claim 10 wherein the variable identifier selected by the user comprises a series of highlighted characters.

15. The method of claim 10 wherein the viewer program analyzes the variable identifier selected by the user to determine if the variable identifier is related to an array data set.

16. The method of claim 15 wherein the viewer program cannot query the debugger program for current array values if the variable identifier is not related to an array data set.

17. The method of claim 15 wherein the viewer program queries the debugger program for current array values if the variable identifier is related to an array data set.

18. The method of claim 10 wherein the current array values are transferred from a database of the debugging program to the viewer program.

19. A viewer program for displaying current array values from a database in a graphical format, the viewer program comprising:
a monitor application for monitoring the viewer program for a selection by a user of a variable identifier;
an analyzer application for analyzing the variable identifier selected by the user to locate an array data set corresponding to the variable identifier;
a receiver application for obtaining the current array values for the array data set from the database; and
a charting application for displaying the current array values for the array data set.
